(19) United States
(12) Patent Application Publication
(10) Pub. No.: US 2026/0156416 A1
(43) Pub. Date: Jun. 4, 2026

(54) Speaker Diaphragm and Speaker

(71) Applicant: Yamaha Corporation, Hamamatsu-shi (JP)

(72) Inventors: Hiroshi NAKASHIMA, Hamamatsu-shi (JP); Kunio Hiyama, Hamamatsu-shi (JP); Makoto Miyazaki, Hamamatsu-shi (JP)

(21) Appl. No.: 19/462,773

(22) Filed: Jan. 28, 2026

Related U.S. Application Data
(63) Continuation of application No. PCT/JP2024/030873, filed on Aug. 29, 2024.

(30) Foreign Application Priority Data
Sep. 1, 2023 (JP) 2023-142350

(51) Int. Cl. H04R 7/12; H04R 7/26; H04R 31/00

(52) U.S. Cl. CPC H04R 7/127; H04R 7/26; H04R 31/003

(57) ABSTRACT

A speaker diaphragm includes a base material including a resin matrix including a thermoplastic resin as a main component, and fibers dispersed within the resin matrix. The fibers include a plurality of loss regions where the fibers are locally bent and broken, or a plurality of loss regions having a diameter 5% to 50% larger than an average diameter of the fibers

### CROSS REFERENCE TO RELATED APPLICATIONS

The present application is a continuation application of International Application No. PCT/JP 2024/030873, filed Aug. 29, 2024, which claims priority to Japanese Patent Application No. 2023-142350, filed Sep. 1, 2023. The contents of these applications are incorporated herein by reference.

### TECHNICAL FIELD

The present disclosure relates to a speaker diaphragm and a speaker.

### BACKGROUND

A speaker diaphragm is desired to have high rigidity so as to generate sound efficiently. Furthermore, speaker diaphragms are required to have excellent environmental resistance, and are also desired to have high water resistance.

From this viewpoint, various speaker diaphragms made of synthetic resin have been proposed today in place of speaker diaphragms made of wood pulp paper.

One example of a synthetic resin speaker diaphragm is a diaphragm made by injection molding polyparaphenylene benzoxazole fiber, which has a high tensile modulus, and polypropylene into a cone shape (see Japanese Unexamined Patent Application, First Publication No. H09-284884).

Also known is a conical diaphragm that is injection molded so that long fibers of 3 to 5 mm in length are contained in a resin and the long fibers are arranged radially from the center of the diaphragm toward the periphery (see Japanese Unexamined Patent Application, First Publication No. 2004-15194).

Furthermore, a speaker diaphragm made of a resin reinforced with polybenzazole fibers having a void diameter of 25 Å or less is known (see Japanese Unexamined Patent Application, First Publication No. H06-253389).

Still further, a speaker diaphragm is known that includes a base material having fibers dispersed in a resin matrix, the fibers being polyparaphenylene benzobisoxazole fibers, and the average length of the fibers being 0.5 mm or more and 3.0 mm or less (see WO 2020/022459).

### SUMMARY

As mentioned above, various speaker diaphragms are available. However, with the speaker diaphragms according to the related art, there is a problem in that it is unclear whether the user can actually experience high-quality reproduced sound.

An object of the present disclosure is to provide a speaker diaphragm and a speaker that can achieve a crisp and clear sound quality.

### Solution to Problem

(1) A speaker diaphragm according to a first aspect of the present disclosure includes a base material including: a resin matrix including a thermoplastic resin as a main component; and fibers dispersed within the resin matrix, and the fibers include a plurality of loss regions where the fibers are locally bent and broken, or a plurality of loss regions having a diameter 5% to 50% larger than an average diameter of the fibers.
(2) A speaker according to a second aspect of the present disclosure includes the above-described speaker diaphragm.

### BRIEF DESCRIPTION OF THE DRAWINGS

FIG. 1 is a schematic front view of a speaker diaphragm according to a first embodiment of the present disclosure.

FIG. 2 is a cross-sectional view of the speaker diaphragm taken along line AA of FIG. 1.

FIG. 3 is an enlarged schematic view of the structure of the speaker diaphragm shown in FIG. 1.

FIG. 4 is a flowchart showing a method for manufacturing a speaker diaphragm according to an embodiment of the present disclosure.

FIG. 5 is a photograph showing an electron microscope image of the fibers used in Example No. 1 of the speaker diaphragm prepared in the examples.

FIG. 6 is a partially enlarged photograph of a fiber shown in FIG. 5.

FIG. 7 is a photograph showing a digital microscope image of other fibers used in a speaker diaphragm prepared in the examples.

FIG. 8 is a photograph showing a digital microscope image of another fiber used in a speaker diaphragm prepared in the examples.

FIG. 9 is a photograph showing an electron microscope image of the fibers used in Example No. 10 of a speaker diaphragm prepared in the examples.

FIG. 10 is a partially enlarged photograph of the fibers shown in FIG. 9.

FIG. 11 is a graph showing an example of evaluation of the damping characteristics of a speaker diaphragm of a comparative example using a spectrogram.

FIG. 12 is a graph showing an example of evaluation of the damping characteristics of the speaker diaphragm according to the present disclosure using a spectrogram.

FIG. 13 is a flowchart illustrating a method for manufacturing a speaker diaphragm according to the embodiment of the present disclosure.

FIG. 14 is a schematic view of a speaker including a speaker diaphragm according to the embodiment of the present disclosure.

### DETAILED DESCRIPTION

Hereinbelow, embodiments of the present disclosure will be described with reference to the drawings.

In the drawings used in the following description, characteristic portions may be enlarged and highlighted for convenience. For the same purpose, non-characteristic parts may be omitted from the illustration.

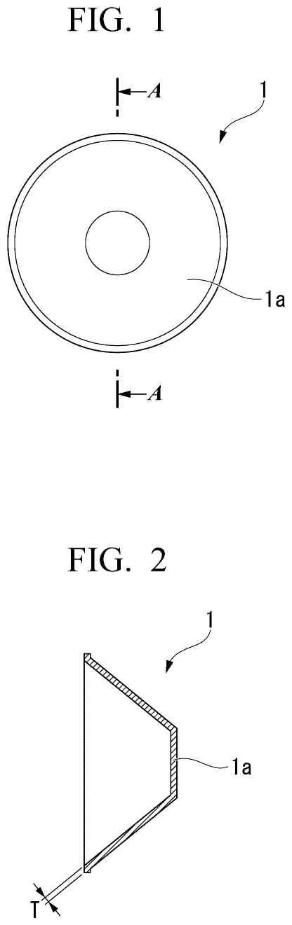

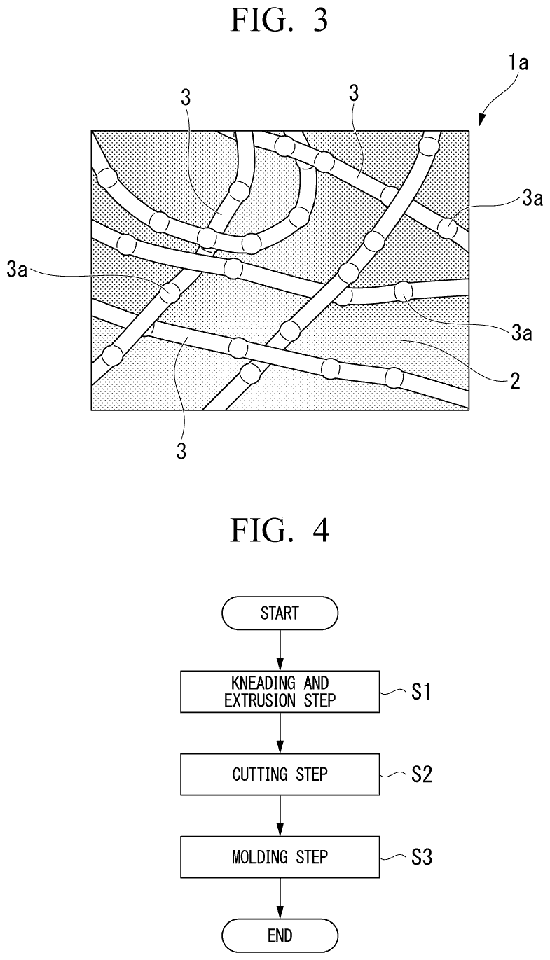

FIG. 1 is a schematic front view showing a speaker diaphragm 1 according to the first embodiment. FIG. 2 is a vertical cross-sectional view of the speaker diaphragm 1. FIG. 3 is an enlarged schematic view of the structure of the speaker diaphragm 1. FIG. 14 is a schematic view showing a speaker S including the speaker diaphragm 1 and a housing H to which the speaker diaphragm 1 is attached.

The diaphragm 1 of the present embodiment is made of a base material 1a having a resin matrix 2 whose main component is a thermoplastic resin and fibers 3 dispersed in this resin matrix 2. For example, the fibers 3 are polyparaphenylene benzobisoxazole fibers, and the average length of the fibers 3 is 0.5 mm or more and 3.0 mm or less.

The fibers 3 dispersed within the resin matrix 2 are polyparaphenylene benzobisoxazole fibers. These fibers make it easy to make the rigidity of the diaphragm 1 sufficiently large. In particular, in the diaphragm 1, since the average length of the polyparaphenylene benzobisoxazole fibers is within the above-mentioned range, the fibers 3 can be uniformly dispersed within the resin matrix 2. As a result, the rigidity of the diaphragm 1 can be increased uniformly over the entire area.

The shape of the diaphragm 1 is preferably conical or domed. The base material 1a of the diaphragm 1 can be configured to include a pair of skin layers that form the surface layers on the front-and rear-surface sides thereof, and a core layer formed between the pair of skin layers.

One embodiment of the manufacturing method of the diaphragm 1 preferably includes a kneading step in which the thermoplastic resin and the fibers 3 are uniformly mixed at high temperature and high shear to produce a kneaded composition, a step in which the kneaded composition is extruded into a rod shape, a step in which the extruded body obtained in the extrusion step is cut into pellets, and a step in which the pellets obtained in the cutting step are injection molded. The fibers 3 are preferably polyparaphenylene benzobisoxazole fibers. The average length of the fibers 3 after the cutting step is preferably 0.5 mm or more and 3.0 mm or less.

According to the above-described manufacturing method, a speaker diaphragm is injection-molded using pellets cut from a rod-shaped extruded body containing a thermoplastic resin and polyparaphenylene benzobisoxazole fibers, and therefore a speaker diaphragm can be manufactured in which the polyparaphenylene benzobisoxazole fibers are dispersed sufficiently uniformly in the thermoplastic resin.

In particular, according to the manufacturing method of the diaphragm 1, the average length of the polyparaphenylene benzobisoxazole fibers in the pellet is within the above-mentioned range, and therefore, in the speaker diaphragm obtained, the fibers 3 can be uniformly dispersed in the thermoplastic resin without becoming entangled.

If the fibers 3 become entangled, clumps of the fibers 3 may form, which may clog the flow path of the material in a manufacturing method such as injection molding. Furthermore, since clumps of the fibers 3 are not uniformly dispersed in the thermoplastic resin, the rigidity of the speaker diaphragm 1 cannot be increased.

On the other hand, according to the manufacturing method of the diaphragm 1, the fibers 3 are interconnected in a spun-like manner, so that the fibers 3 can be uniformly dispersed in the thermoplastic resin, thereby increasing the rigidity of the diaphragm 1. That is, the manufacturing method of the diaphragm 1 can manufacture a speaker diaphragm having uniformly increased rigidity over the entire area.

In the present disclosure, the term “main component” refers to the component with the highest content by mass. For example, “main component” means a component whose content is 50 mass % or more, preferably a component whose content is 70 mass % or more, and more preferably a component whose content is 90 mass % or more. “Average fiber length” means the average length of any 10 fibers. “Front-surface side” means the side in the sound emission direction. “Rear-surface side” means the side opposite to the sound output direction. “Surface layer” refers to a region of the object or layer of interest that is 50μm or less in depth from the front and back surfaces. When the object is thin, such as 100μm, approximately one-third of the thickness of the object may be regarded as the surface layer.

Hereinbelow, embodiments of the present disclosure will be described with reference to the drawings as appropriate.

### Speaker Diaphragm

The speaker diaphragm 1 shown in FIGS. 1 to 3 is made of a base material 1a having a resin matrix 2 whose main component is a thermoplastic resin and fibers 3 dispersed within the resin matrix 2. The diaphragm 1 consists of the base material 1a alone.

The diaphragm 1 can be configured to have a shape suited to the speaker to be used, and is conical or domed in FIGS. 1 and 2. That is, the base material 1a itself is conical or domed. When the diaphragm 1 is conical or domed, the strength of the diaphragm 1 is further increased. The size of the diaphragm 1 can be set to suit the speaker to be used. The diaphragm 1 may be used in a small speaker provided in, for example, headphones, earphones, portable electronic devices, and the like.

### Base Material

The diaphragm 1 is made of a base material 1a including a resin matrix 2 and fibers 3 dispersed within the resin matrix 2. The base material 1a can be formed by injection molding or press molding, which will be described later. The base material 1a may have a pair of skin layers constituting the surface layers on the front-and rear-surface sides thereof, and a core layer formed between the pair of skin layers. That is, the core layer may be interposed between the pair of skin layers. The pair of skin layers are formed from the resin matrix 2 and the fibers 3 that contacted and flowed along the cavity surface of the mold during injection molding to form the surface layers. The core layer is a layer formed from the resin matrix 2 and fibers 3 that cool and solidify relatively slowly without coming into contact with the cavity surface of the mold. In the diaphragm 1, the orientation direction of the fibers 3 in the skin layers may be different from the orientation direction of the fibers 3 in the core layer.

The base material 1a of the speaker diaphragm 1 (in this embodiment, the speaker diaphragm 1 itself) has a substantially uniform thickness. The lower limit of the average thickness T of the base material 1a of the speaker diaphragm 1 is preferably 50 μm, and more preferably 80 μm. The upper limit of the average thickness T of the base material 1a of the speaker diaphragm 1 is preferably 800 μm, and more preferably 650 μm. If the average thickness T is less than the lower limit, the speaker diaphragm 1 may not have sufficient rigidity, or it may be difficult to form the speaker diaphragm 1 by injection molding. Conversely, if the average thickness T exceeds the upper limit, the speaker diaphragm 1 may become unnecessarily heavy. “Approximately uniform thickness” means that the ratio of the maximum thickness to the minimum thickness is 1 or more and 1.20 or less. “Average thickness” means the average value of thicknesses at any 10 points. The ratios described above for “approximately uniform thickness” are for speaker diaphragms of substantially uniform thickness, and do not apply to a speaker diaphragm intentionally provided with ribs or the like.

### Resin Matrix

As described above, the main component of the resin matrix 2 is a thermoplastic resin. Examples of the thermoplastic resin include polyethylene, polypropylene, polystyrene, fluororesin, polycarbonate, polysulfone, polyethersulfone, polyethylene terephthalate, polybutylene terephthalate, polyamide, polyimide, and acrylonitrile-butadiene-styrene resin, and these may be used alone or in combination of two or more. In particular, polypropylene is preferred as the thermoplastic resin. By using polypropylene as the thermoplastic resin, the vibration damping rate (internal loss) of the speaker diaphragm 1 at audible frequencies can be increased. Furthermore, when the thermoplastic resin is polypropylene, it becomes easy to disperse the fibers 3 in a non-bonded state with the resin matrix 2, as will be described later. This further increases the vibration damping rate, making it easier to improve sound reproducibility. At least a portion of the fibers 3 may not be bonded to the resin matrix 2. In some cases, the fibers 3 may not be bonded to the resin matrix 2 at all.

### Fibers

The fibers 3 are polyparaphenylene benzobisoxazole fibers having a plurality of loss regions 3a, which will be described in detail later. By using polyparaphenylene benzobisoxazole fibers as the fibers 3, the rigidity of the diaphragm 1 can be increased while suppressing a decrease in the vibration damping rate of the diaphragm 1.

The content of the fibers 3 in the base material 1a is preferably in the range of 3 mass % or more and 30 mass % or less.

The lower limit of the content of the fibers 3 in the base material 1a (in other words, the content of the fibers 3 in the diaphragm 1) is preferably 3 mass %, and more preferably 5 mass %. On the other hand, the upper limit of the content of the fibers 3 in the base material 1a is preferably 30 mass %, more preferably 22 mass %, and even more preferably 15 mass %. If the content of the fibers 3 is less than the lower limit, the rigidity of the diaphragm 1 may be insufficient. On the other hand, if the content of the fibers 3 exceeds the upper limit, the fibers 3 may become entangled with each other in the resin matrix 2, and the uniform dispersion of the fibers 3 in the resin matrix 2 may become insufficient. Furthermore, if the content of the fibers 3 exceeds the upper limit, when a resin composition containing a resin and a thermoplastic resin is heated and passed through the nozzle or the like of the injection molding device, uneven distribution of the fibers 3 may cause clogging, which may make the diaphragm 1 difficult to manufacture.

The lower limit of the average length of the fibers 3 is 0.5 mm, and preferably 1.0 mm. On the other hand, the upper limit of the average length of the fibers 3 is preferably 3.0 mm, more preferably 2.5 mm, and most preferably 1.5 mm. If the average length of the fibers 3 is less than the lower limit, the effect of improving the rigidity due to the fibers 3 may be insufficient. On the other hand, if the average length of the fibers 3 exceeds the upper limit, the fibers 3 tend to become entangled with each other, and the uniform dispersion of the fibers 3 in the resin matrix 2 may become insufficient. The length of individual fibers 3 dispersed within the resin matrix 2 may be non-uniform as long as the average length is within the above-mentioned range.

The upper limit of the maximum length of the fibers 3 dispersed within the resin matrix 2 is preferably 5.0 mm, more preferably 4.0 mm, and even more preferably 3.0 mm. In this way, by setting the maximum length of the fibers 3 to the above upper limit or less, it is easy to reliably prevent the fibers 3 from becoming entangled with each other.

The average aspect ratio of the fibers 3 is preferably in the range of 20 to 300.

The lower limit of the average aspect ratio of the fibers 3 is preferably 20, and more preferably 50. On the other hand, the upper limit of the average aspect ratio of the fibers 3 is preferably 300, and more preferably 200. If the average aspect ratio is less than the lower limit, it may be difficult to control the orientation direction of the fibers 3. On the other hand, if the average aspect ratio exceeds the upper limit, the fibers 3 may easily become entangled with each other. The “average aspect ratio of the fibers” means the average value of the ratio of the length to the diameter measured for any 10 randomly selected fibers. The diameter of the fibers may be 10 μm or more and 50 μm or less. The average diameter of the fibers may be 10 μm or more and 50 μm or less.

This allows speaker diaphragm 1 to have a large vibration damping rate. In the speaker diaphragm 1, from the viewpoint of increasing the rigidity by the fibers 3, it is preferable that there be no gap between the resin matrix 2 and the fibers 3. In the diaphragm 1, the fibers 3 and the thermoplastic resin described above are incompatible and not chemically bonded to each other, so that the fibers 3 can be held in an unbonded state with the resin matrix 2. Furthermore, even if the fibers 3 and the thermoplastic resin are not chemically bonded to each other, the speaker diaphragm 1 can have the fibers 3 uniformly dispersed within the resin matrix 2 by controlling the content and average length of the fibers 3 within the aforementioned ranges.

### Loss Area

As shown in FIG. 3, each of the fibers 3 has a plurality of kink-shaped or lump-shaped loss regions 3a formed intermittently along its length. The loss region 3a is a portion that is generated by kneading and extruding the fibers under special conditions in a manufacturing method that will be described in detail later, so that a strong shear force acts on the fibers.

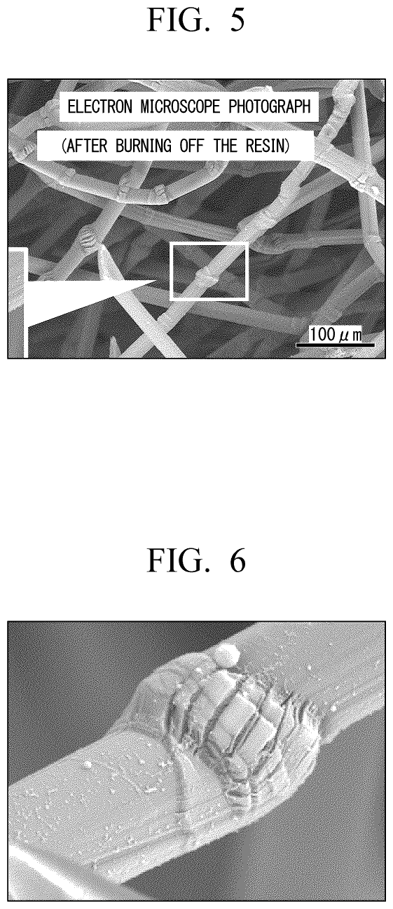

The loss regions 3a are portions formed so as to bulge outward from the outer periphery of the fiber 3 like nodes at arbitrary intervals along the length of the fiber 3, as shown in FIGS. 5 and 6 described later in the examples. The loss region 3a can be explained as a observed portion of the fiber 3 that has undergone plastic deformation such as bending, twisting, or crushing under high temperature and high shear conditions, resulting in a radially outward bulge of the fiber 3, or in buckling of the fiber. The buckled portion of the fiber can also be described as a loss region called a kink band, where the fiber is locally bent and broken. In addition to the loss region 3a (kink band), the fiber 3 may further contain simple scratches, damages, chips, bends, or the like.

It is preferable that about 1 to 10 loss regions 3a be formed over a length 30 times the average diameter of the fibers 3. For example, when the average diameter of the fibers 3 is 10 μm, about 1 to 10 are formed over a length of 300 μm.

The loss region 3a is a portion formed by applying a strong shear force to the fibers. Therefore, the diameter of the loss region 3a is larger than the average diameter of the fibers 3. The diameter of the loss region 3a is 1.1 to 2 times the average diameter of the fibers 3. For example, when the average diameter of the fibers 3 is 10 μm, the diameter of the loss region 3a is 11 μm or more and 20 μm or less. The diameter of the loss region 3a may be 5% to 50% larger than the average diameter of the fibers 3. The loss region 3a may have an average diameter that is 5% to 50% larger than the average diameter of the fibers 3. The diameter of the loss region 3a may be 12 μm or more and 80 μm or less. The average diameter of the loss region 3a may be 12 μm or more and 80 μm or less.

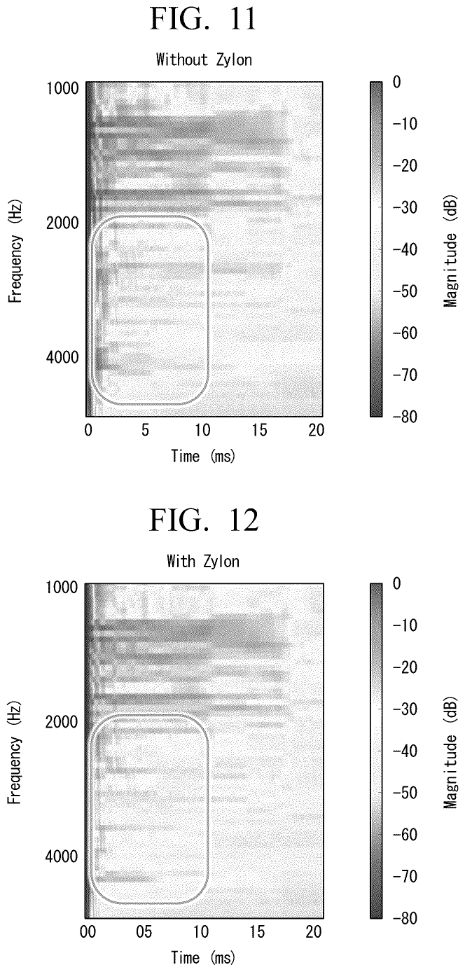

If the number of the loss regions 3a is less than the lower limit, the damping effect in a predetermined frequency band will be insufficient, making it difficult to obtain a crisp reproduced sound in this frequency band. In the examples of FIGS. 11 and 12, the damping effect in the range of 2000 to 4200 Hz is insufficient. If the number of loss regions 3a exceeds the above-mentioned upper limit, it becomes difficult to mass-produce the lumps, resulting in a problem of high manufacturing costs.

### Other Ingredients

The base material 1a of the diaphragm 1 may contain components other than the resin matrix 2 and the fibers 3, as long as the effects of the present disclosure are not impaired. The other components may include, for example, a colorant such as titanium oxide, an ultraviolet absorber, a compatibilizer, and the like.

### Advantages

The diaphragm 1 has polyparaphenylene benzobisoxazole fibers 3 dispersed within the resin matrix 2 of its base material 1a, and the fibers have multiple loss regions 3a, so that the fibers 3 increase rigidity and the loss regions 3a tend to increase loss. In particular, the average length of the polyparaphenylene benzobisoxazole fibers in the diaphragm 1 is within the above-mentioned range. Therefore, for example, by controlling the content of the fibers 3 within the above-mentioned range, the fibers 3 can be uniformly dispersed within the resin matrix 2. As a result, the rigidity of the speaker diaphragm 1 can be increased uniformly over the entire area. Adding about 10 mass % of fiber is thought to increase stiffness by about 20%, and is also estimated to have a significant effect on increasing loss. Furthermore, when about 10 mass % of fibers is added, the loss modulus, which affects the loss characteristics, is also improved.

Each fiber 3 has a plurality of loss regions 3a. Therefore, by including the fibers 3 in the base material 1a in the above-mentioned percentage by mass, the friction loss mechanism increases, and the damping of the diaphragm 1 can be increased.

Therefore, a speaker having the diaphragm 1 can reproduce a tight, sharp sound with significant damping. For example, in the frequency band of 2000 to 4200 Hz, a crisp and clear reproduced sound can be obtained.

### Method of Manufacturing Speaker Diaphragm

Next, a method for manufacturing the diaphragm 1 shown in FIG. 1 will be described with reference to FIG. 4. The method of manufacturing the diaphragm 1 according to the present embodiment includes a kneading step of uniformly mixing the thermoplastic resin and the fibers 3 at high temperature and high shear to produce a kneaded composition, a step (kneading and extrusion step) S1 of extruding the kneaded composition into a rod shape, a step (cutting step) S2 of cutting the extruded body extruded in the kneading and extrusion step S1 into pellets, and a step (molding step) S3 of injection molding the pellets obtained in the cutting step S2.

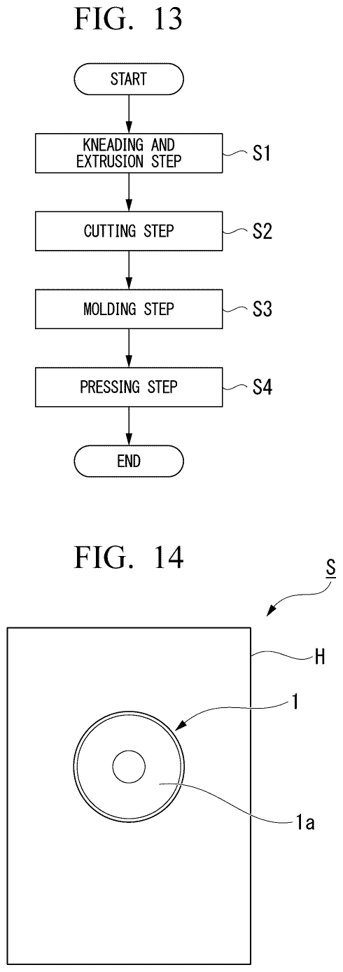

When molding thin objects such as tweeter (Tw) diaphragms and headphone diaphragms, it is preferable that the method of manufacturing the diaphragm 1 includes a pressing step S4, which press-molds the pre-shaped product obtained by the injection molding, as described below (see FIG. 13).

### Kneading and Extrusion Step S1

In the kneading and extrusion step S1, a resin composition containing a thermoplastic resin and fibers 3 is kneaded and extruded into a rod shape. The kneading and extrusion step S1 can be carried out using an extrusion molding device. The extrusion molding device includes, for example, an extruder that has a cylinder that guides the resin composition and a screw that is attached inside the cylinder and that kneads the resin composition, a T-die that extrudes the resin composition kneaded by the extruder into a rod-like form, and a cooling portion that cools the resin composition extruded from the T-die.

In the kneading and extrusion step S1, the resin composition is extruded into a rod shape and then cooled in the cooling portion, thereby solidifying the resin composition in the shape it had when extruded. This results in a rod-shaped extruded body.

The screw used for kneading is preferably of a type that can apply a sufficient shear force to the fibers used in the present embodiment. A conventional screw is a type in which a uniform spiral groove is formed on the outer periphery of the shaft, but in the present embodiment, it is preferable to use a special type of screw called a Dulmage screw. The Dulmage screw is configured by arranging multiple wedge-shaped kneading promotion portions along the longitudinal center of the screw shaft, which has a spiral groove formed thereon, the portions having small spiral grooves with a different pitch from the spiral grooves in other parts. By providing these kneading promotion portions, the pellets can be mixed while being kneaded, and a larger shear force can be applied to the fibers in the pellets.

The thermoplastic resin used in the kneading and extrusion step S1 may be the thermoplastic resin described above that is contained as the main component of the resin matrix 2 of the base material 1a of the diaphragm 1 shown in FIG. 1. In particular, polypropylene is preferred as the thermoplastic resin.

The fibers 3 used in the kneading and extrusion step S1 are polyparaphenylene benzobisoxazole fibers. The length of each polyparaphenylene benzobisoxazole fiber is not particularly limited, but may be, for example, 1 mm or more and 10 mm or less, and preferably 1 mm or more and 3 mm or less. If the fibers are too long, they will be difficult to knead and will become entangled and difficult to enter the cylinder. If the fibers are too short, the sound will not be good. In particular, when a thin diaphragm such as a tweeter (Tw) is used, it is desirable that the fibers be short, as long fibers tend to clump together and cannot be dispersed uniformly.

In the method of manufacturing a speaker diaphragm, the length of the fibers 3 contained in the base material 1a of the obtained diaphragm 1 can be adjusted within the aforementioned range by adjusting the length of the pellets in the cutting process S2 described below.

The lower limit of the content of the fibers 3 in the resin composition is preferably 3 mass %, more preferably 6 mass %. On the other hand, the upper limit of the content of the fibers 3 is preferably 30 mass %, more preferably 22 mass %, and even more preferably 15 mass %. If the content of the fibers 3 is less than the lower limit, the rigidity of the obtained speaker diaphragm 1 may be insufficient. On the other hand, if the content of the fibers 3 exceeds the upper limit, the fibers 3 may not be dispersed uniformly in the resin matrix 2 in an adequate manner.

The resin composition may contain, as other components, a colorant such as titanium oxide, an ultraviolet absorber, a compatibilizer for making the thermoplastic resin and the fibers 3 compatible with each other, and the like.

### Cutting Step S2

In the cutting step S2, the extruded body extruded in the kneading and extrusion step S1 is cut at equal intervals in the longitudinal direction to form a plurality of cylindrical pellets. The fibers 3 contained in the extruded body tend to be oriented in the extrusion direction. Therefore, by cutting the extruded body at equal intervals, the average length of the fibers 3 can be kept equal to or less than the length of the pellets. In the cutting step S2, the polyparaphenylene benzobisoxazole fibers having a length within the aforementioned range are cut into two or more pieces in the longitudinal direction at the same time as forming the pellets, which makes it easy to adjust the length of the fibers 3 contained in the base material 1a of the obtained speaker diaphragm 1 to be non-uniform. In the cutting step S2, the extruded body is cut at intervals of, for example, 3 mm or less to form a plurality of cylindrical pellets each having a length of 3 mm or less.

The lower limit of the average length of the fibers 3 after the cutting step is 0.5 mm, and preferably 1.0 mm. On the other hand, the upper limit of the average length of the fibers 3 after the cutting step is 3.0 mm, preferably 2.5 mm, and more preferably 1.5 mm. If the average length of the fibers 3 is less than the lower limit, the rigidity of the resulting diaphragm 1 may not be increased sufficiently. Conversely, if the average length of the fibers 3 exceeds the upper limit, the fibers 3 will be more likely to become entangled in the base material 1a of the resulting speaker diaphragm 1, and the uniform dispersion of the fibers 3 in the resin matrix 2 may be insufficient.

### Molding Step S3

In the molding step S3, the base material 1a of the diaphragm 1 is formed by injection molding the pellets obtained in the cutting step S2. The molding step S3 can be performed using an injection molding device. This injection molding device has, for example, a cylinder with a nozzle at the tip, a hopper connected to the cylinder and into which the pellets obtained in the cutting step are poured, a screw mounted inside the cylinder, and a mold having a cavity formed therein that communicates with the opening of the nozzle.

The cavity has an inverted shape of the base material 1a of the diaphragm 1. The cavity is connected to the nozzle opening at a portion corresponding to the bottom (the center when viewed in the axial direction) of the base material 1a of the diaphragm 1. In the molding step S3, the resin composition (melt of the pellets) is filled radially into the cavity from the portion corresponding to the bottom. In the molding step S3, the cavity is cooled after being filled with the resin composition, and the resin composition is cured. The resin composition is cured and molded into a molded product, which serves as the base material 1a of the diaphragm 1.

The lower limit of the temperature inside the cavity in the molding step S3 is preferably 30° C. On the other hand, the upper limit of the temperature inside the cavity is preferably 50° C. If the temperature inside the cavity is below the lower limit, the fluidity of the resin inside the cavity will be insufficient, and it may become difficult to control the orientation direction of the fibers 3. Conversely, if the temperature inside the cavity exceeds the upper limit, it may become difficult to sufficiently cool the resin composition after filling the cavity, and it may become difficult to remove the base material 1a of the obtained diaphragm 1 from the cavity.

The lower limit of the injection speed of the resin composition in the molding step S3 is preferably 80 mm/s, and more preferably 100 mm/s. On the other hand, the upper limit of the injection speed is preferably 1000 mm/s, and more preferably 500 mm/s. If the injection speed is less than the lower limit, the fluidity of the resin composition in the cavity may be insufficient, which may make it difficult to control the orientation direction of the fibers 3 in the cavity. Conversely, if the injection speed exceeds the upper limit, the fluidity of the resin composition in the cavity becomes too high, which may make it difficult to control the orientation direction of the fibers 3 in the cavity.

### Advantages

In the manufacturing method according to the present embodiment, the base material 1a of the diaphragm 1 is injection molded using pellets cut from a rod-shaped extruded body containing a thermoplastic resin and polyparaphenylene benzobisoxazole fibers. This makes it possible to manufacture a speaker diaphragm in which polyparaphenylene benzobisoxazole fibers with damping regions are dispersed sufficiently uniformly in a thermoplastic resin.

In particular, in the method for manufacturing a diaphragm, the average length of the polyparaphenylene benzobisoxazole fibers in the pellet is within the above-mentioned range. Therefore, for example, the content of the polyparaphenylene benzobisoxazole fibers with the damping region in the resin composition can be controlled within the above-mentioned range. Therefore, in the base material 1a of the obtained speaker diaphragm, the fibers can be uniformly dispersed in the thermoplastic resin without becoming entangled. As a result, the above-described manufacturing method makes it possible to manufacture the speaker diaphragm 1 having uniformly increased rigidity over the entire area.

### Pressing Step S4

### Method for Forming Thin Films for Tweeters (TW) and Headphone Diaphragms

An injection-molded preform in the shape of a diaphragm, 0.3 to 0.5 mm, is placed in a press mold with a cavity of the target thickness (approximately 100 μm) that has been heated to (melting point to melting point +50° C.) and pressurized. The preform is held for about 10 to 30 seconds, then cooled to (melting point −50 to melting point −100° C.) and removed from the mold.

### Other Embodiments

The above-described embodiment does not limit the configuration of the present disclosure. Therefore, in the embodiments, it is possible to omit, replace, or add components of the respective parts of the embodiments based on the descriptions in this specification and common technical knowledge, and all of these should be interpreted as belonging to the scope of the present disclosure.

For example, the diaphragm does not necessarily have to be conical, but may be domed or flat.

### EXAMPLES

### No. 1

A resin composition containing polypropylene (manufactured by Japan Polypropylene Corporation) as a thermoplastic resin containing pigments and additives, and polyparaphenylene benzobisoxazole fibers (“Zylon” (registered trademark) manufactured by Toyobo Co., Ltd.) having a fiber length of 1 mm was kneaded and extruded into a rod shape in a single-screw extruder.

The extruded resin composition was cooled and solidified in the shape at the time of extrusion (kneading and extrusion step). The content of polypropylene in this resin composition was 95 mass %, and the content of polyparaphenylene benzobisoxazole fiber was 5 mass %. The extrusion conditions were a discharge rate of 2 kg/h and an extrusion temperature of 165° C. to 190° C.

The extrudate obtained from the kneading and extrusion step was cut into pellets with a length of 3 mm (cutting step). Furthermore, the cylindrical pellets obtained by cutting in the cutting step were injection molded in an injection molding machine, whereby the speaker diaphragm No. 1 (single base material) was obtained.

This injection molding device has a cylinder with a nozzle at the tip, a hopper connected to the cylinder and into which the pellets obtained in the cutting process are poured, a screw mounted inside the cylinder, and a mold having a cavity formed therein that communicates with the opening of the nozzle.

The screw used was a Dulmage screw manufactured by Nippon Oil Machinery Co., Ltd., which was configured to have three wedge-shaped kneading promotion portions along the longitudinal center of the screw shaft, each having small spiral grooves with different pitches.

The cavity has a cone-shaped internal space, and the opening of the nozzle communicates with the bottom of this internal space. The injection molding conditions were as follows: cylinder temperature 200° C. to 220° C., mold temperature 45° C., injection speed 400 mm/s, injection pressure 200 MPa, and back pressure 8 MPa.

### No. 2

Speaker diaphragm No. 2 (base material alone) was produced under the same conditions as speaker diaphragm No. 1, except that Zylon ((registered trademark) manufactured by Toyobo Co., Ltd.) having a fiber length of 3 mm was used as the polyparaphenylene benzobisoxazole fiber, the polypropylene content in the resin composition was 90 mass %, and the polyparaphenylene benzobisoxazole fiber content was 10 mass %.

### No. 3

Speaker diaphragm No. 3 (base material alone) was produced under the same conditions as speaker diaphragm No. 1, except that Zylon ((registered trademark) manufactured by Toyobo Co., Ltd.) having a fiber length of 1 mm was used as the polyparaphenylene benzobisoxazole fiber, the polypropylene content in the resin composition was 85 mass %, and the polyparaphenylene benzobisoxazole fiber content was 15 mass %.

### No. 4

Speaker diaphragm No. 4 (base material alone) was produced under the same conditions as speaker diaphragm No. 1, except that Zylon ((registered trademark) manufactured by Toyobo Co., Ltd.) having a fiber length of 3 mm was used as the polyparaphenylene benzobisoxazole fiber, the polypropylene content in the resin composition was 78.6 mass %, and the polyparaphenylene benzobisoxazole fiber content was 21.4 mass %.

### No. 5

Speaker diaphragm No. 5 (base material alone) was produced under the same conditions as speaker diaphragm No. 1, except that Zylon ((registered trademark) manufactured by Toyobo Co., Ltd.) having a fiber length of 1 mm was used as the polyparaphenylene benzobisoxazole fiber, the polypropylene content in the resin composition was 90 mass %, and the polyparaphenylene benzobisoxazole fiber content was 10 mass %.

### No. 6

Speaker diaphragm No. 6 (base material alone) was produced under the same conditions as speaker diaphragm No. 1, except that the polypropylene content in the resin composition was 90 mass %, and the polyparaphenylene benzobisoxazole fiber content was 10 mass %.

### No. 7

Speaker diaphragm No. 7 (base material alone) was produced under the same conditions as speaker diaphragm No. 1, except that Zylon ((registered trademark) manufactured by Toyobo Co., Ltd.) having a fiber length of 1 mm was used as the polyparaphenylene benzobisoxazole fiber, the polypropylene content in the resin composition was 80 mass %, and the polyparaphenylene benzobisoxazole fiber content was 20 mass %.

### No. 8

Speaker diaphragm No. 8 (base material alone) was produced under the same conditions as speaker diaphragm No. 1, except that Zylon ((registered trademark) manufactured by Toyobo Co., Ltd.) having a fiber length of 1 mm was used as the polyparaphenylene benzobisoxazole fiber, the polypropylene content in the resin composition was 70 mass %, and the polyparaphenylene benzobisoxazole fiber content was 30 mass %.

### No. 9

Speaker diaphragm No. 9 (base material alone) was produced using 100% polypropylene (manufactured by Japan Polypropylene Co., Ltd.) containing no polyparaphenylene benzobisoxazole fiber, with injection molding performed using the above-mentioned injection molding device.

### No. 10

Speaker diaphragm No. 10 (base material alone) was produced under the same conditions as speaker diaphragm No. 1, except that Twaron ((registered trademark) manufactured by Teijin Limited) with a fiber length of 6 mm was used as the para-aramid fiber, the polypropylene content in the resin composition was 90 mass %, and the para-aramid fiber content was 10 mass %.

FIG. 5 is a photograph showing the results of electron microscope observation of the base material of the speaker diaphragm No. 1, obtained by heating the resin matrix at 400° C. to burn it off, leaving only the fibers (residue left after the resin was decomposed and removed). FIG. 6 shows a photograph of one of the loss regions formed in the fiber shown in FIG. 5, observed under an electron microscope at a magnified view.

As shown in FIG. 5, it was confirmed that multiple nodular loss regions were formed intermittently along the length direction of the fiber, and that one of these loss regions had a lump-like kink, where the fiber had broken and a partial crack had formed, as shown in FIG. 6.

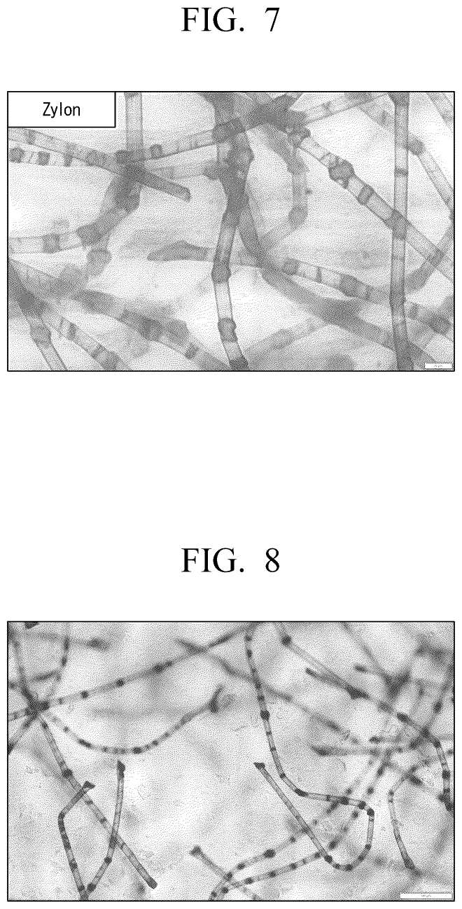

According to any of the examples of manufacturing conditions described in No. 2 to No. 9, a base material for a diaphragm could be manufactured in the same manner as in Example No. 1. FIGS. 7 and 8 show the results of observing the fibers with a digital microscope after the resin matrix was burned away, leaving only the fibers.

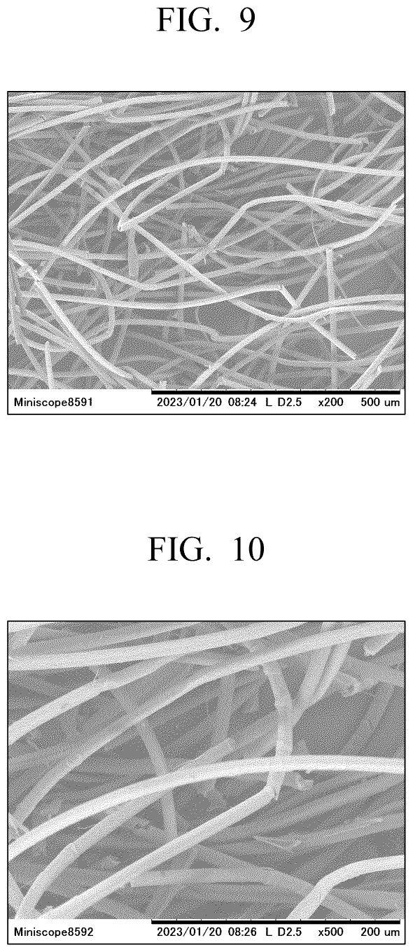

FIG. 9 is a photograph showing the results of electron microscope observation of the base material of the speaker diaphragm No. 10, obtained by heating the resin matrix at 400° C. to burn it off, leaving only the fibers (residue left after the resin was decomposed and removed). FIG. 10 shows a photograph of one of the loss regions formed in the fibers shown in FIG. 9, observed under an electron microscope at a magnified view.

As shown in FIG. 9, it was confirmed that multiple nodular loss regions were formed intermittently along the length direction of the fiber, and in one of these loss regions, the fiber was broken and partially buckled, and a kink band occurred, as shown in FIG. 10.

The cumulative spectrum of the reproduced sounds obtained from the speaker diaphragms No. 1 and No. 9 was measured in the following manner.
1. Mount the target speaker unit in the housing of a Yamaha monitor speaker HS7.
2. The impulse response of this speaker is obtained at 1 m on the axis in an anechoic chamber.
3. The (falling) cumulative spectrum is calculated from the obtained impulse response and expressed as a contour diagram.

The cumulative spectrum was determined by referring to the literature “J. Audio Eng. Soc., vol. 25, p. 370(1977 ).”

The measurement results for diaphragm No. 9 are shown in FIG. 11, and the measurement results for diaphragm No. 1 are shown in FIG. 12.

As is clear from a comparison of the damping characteristics shown in FIGS. 11 and 12, it was confirmed that the diaphragm containing polyparaphenylene benzobisoxazole fiber having multiple damping regions had less reverberation in the reproduced sound in the range of 2000 to 4200 Hz.

These results show that the diaphragm containing polyparaphenylene benzobisoxazole fiber with a damping region is able to reproduce crisper and clearer sound.

As described above, the speaker diaphragm according to the present disclosure can be suitably used as a relatively inexpensive diaphragm that can uniformly increase rigidity by incorporating fibers and can reproduce clear and crisp sound in a predetermined frequency band (for example, a frequency band of 2000 to 4200 Hz).

According to the present disclosure, it is possible to provide a speaker diaphragm that can achieve a crisp and clear sound quality.

What is claimed is:

1. A speaker diaphragm comprising
a base material comprising: a resin matrix including a thermoplastic resin as a main component; and
fibers dispersed within the resin matrix,
wherein the fibers include a plurality of loss regions where the fibers are locally bent and broken, or a plurality of loss regions having a diameter 5% to 50% larger than an average diameter of the fibers.

2. The speaker diaphragm according to claim 1, wherein a content of the fibers in the base material is 3 mass % or more and 15 mass % or less.

3. The speaker diaphragm according to claim 1, wherein a number of the plurality of loss regions is one or more in a range along a longitudinal direction of the fibers extending over a length equal to 30 times the average diameter of the fibers.

4. The speaker diaphragm according to claim 1, wherein a number of the plurality of loss regions is one or more and 10 or less in a range along a longitudinal direction of the fibers extending over a length equal to 30 times the average diameter of the fibers.

5. The speaker diaphragm according to claim 1, wherein the fibers are polyparaphenylene benzobisoxazole fibers.

6. The speaker diaphragm according to claim 1, wherein a diameter of the fibers is 10 μm or more and 50 μm or less.

7. The speaker diaphragm according to claim 1, wherein a diameter of the loss regions is 12 μm or more and 80 μm or less.

8. The speaker diaphragm according to claim 1, wherein the plurality of loss regions where the fibers are locally bent and broken are kink bands.

9. A speaker comprising the speaker diaphragm according to claim 1.
